(19) United States
(12) Patent Application Publication
(10) Pub. No.: US 2026/0367397 A1
(43) Pub. Date: Nov. 19, 2026

(54) METHOD OF MANUFACTURING A LENS FOR AN AUGMENTED REALITY DEVICE, A LENS FOR AN AUGMENTED REALITY DEVICE, AND AUGMENTED REALITY DEVICE HAVING THE SAME

(71) Applicant: CLAROPTIC CO., Ltd., Seongnam-si (KR)

(72) Inventor: Min-kyu SONG, Seoul (KR)

(21) Appl. No.: 19/653,499

(22) Filed: Apr. 21, 2026

(30) Foreign Application Priority Data
May 19, 2025 (KR) 10-2025-0064349

(51) Int. Cl. G02B 27/01; B29D 11/00; G02B 1/10

(52) U.S. Cl. CPC G02B 27/0101; B29D 11/00403; B29D 11/00442; B29D 11/00807; G02B 1/10

(57) ABSTRACT

A method of manufacturing a lens for an augmented reality device, a lens for an augmented reality device, and an augmented reality device having the lens are described. The method of manufacturing a lens for an augmented reality device may include: fabricating a first lens piece, where the first lens piece may have an inclined surface between a first-direction end and a second-direction end of the first lens piece with respect to a lengthwise direction, the inclined surface may be exposed to an outer side and may form a particular angle with respect to the lengthwise direction, and a first optical element may be formed on the inclined surface; inserting the first lens piece into a mold and injecting a monomer material into the mold such that the first optical element is covered with the monomer material; and fabricating a second lens piece by polymerizing the monomer material.

### CROSS-REFERENCE TO RELATED APPLICATIONS

This application claims the benefit of Korean Patent Application No. 10-2025-0064349, which was filed with the Korean Intellectual Property Office on May. 19, 2025, and registered as Korean Registered Patent No. 10-2931221. The disclosure of the above patent application is incorporated herein by reference in its entirety.

### BACKGROUND

### 1. Technical Field

The present invention relates to an augmented reality device for providing the user with a2 virtual image and a real image simultaneously. More particularly, the invention relates to a method of manufacturing a lens for an augmented reality device, a lens for an augmented reality device, and an augmented reality device having the lens.

### 2. Description of the Related Art

Augmented reality (AR) is a technology for superimposing digital information over a real world image. Through augmented reality, a user may use a device such as a smart phone, eyeglasses, a headset, etc., to see the actual environment and a virtual image together in real time. This technology, which is utilized in various fields such as gaming, education, medicine, manufacturing, etc., expands the user’s experience by adding virtual elements onto real world surroundings.

A device for implementing augmented reality may include hardware and software that are capable of recognizing the real world and displaying virtual information. Such hardware devices may include smart phones, tablets, AR glasses, HMDs (head-mounted displays), and the like. These devices utilize cameras, sensors, GPS, etc., to recognize the user’s position and the surrounding environment and show 3D graphics, text, images, etc., onto a screen in real time based on the recognized information, whereby the user may experience the real world and the virtual information simultaneously.

The most recently developed augmented reality devices are mostly of a wearable form, such as in the case of AR glasses, so that there is a need for reducing the thickness and weight of AR lenses.

### SUMMARYOF THE INVENTION

An aspect of the present invention, which was conceived to resolve the problem described above, is to provide a method of manufacturing a lens for an augmented reality device, a lens for an augmented reality device, and an augmented reality device having the lens, with which the lens having an embedded optical element for use in an augmented reality device can be manufactured with high precision at a low cost.

Other objectives of the present invention will be more clearly understood from the embodiments set forth below.

One aspect of the invention provides a method of manufacturing a lens for an augmented reality device. The method of manufacturing a lens for an augmented reality device may include: fabricating a first lens piece, where the first lens piece may have an inclined surface between a first-direction end and a second-direction end of the first lens piece with respect to a lengthwise direction, the inclined surface may be exposed to an outer side and may form a particular angle with respect to the lengthwise direction, and a first optical element may be formed on the inclined surface; inserting the first lens piece into a mold and injecting a monomer material into the mold such that the first optical element is covered with the monomer material; and fabricating a second lens piece by polymerizing the monomer material.

A method of manufacturing a lens for an augmented reality device according to an embodiment of the invention can include one or more of the following features. For example, a cavity of a recessed form can be formed in the first lens piece, and the inclined surface can be formed on a first-direction surface of the cavity or a second-direction surface of the cavity. In such cases, a first inclined surface can be formed on the first-direction surface of the cavity, a second inclined surface can be formed on the second-direction surface of the cavity, the first optical element can be formed on the first inclined surface, and a second optical element can be formed on the second inclined surface.

The mold can include a protrusion that protrudes towards the cavity at a position corresponding to the cavity. The protrusion can be configured not to be in contact with at least a portion of the first optical element.

Fabricating the first lens piece can include forming a second optical element on a first-direction end of the first lens piece.

Fabricating the first lens piece can include: injecting a preliminary material into a preliminary mold, where the preliminary mold may have a shape corresponding to the shape of the first lens piece, and the preliminary material may have the same composition as the monomer material; and polymerizing the preliminary material.

A light-emitting element can be formed at a position of the second lens piece closer to a first-direction end of the second lens piece than the first optical element, by forming the light-emitting element on a first-direction end of the first lens piece during the fabricating of the first lens piece, or by injecting the monomer material after arranging the light-emitting element at a first-direction end of the mold during the injecting of the monomer material, or by forming the light-emitting element on the first-direction end of the second lens piece during the fabricating of the second lens piece.

The light-emitting element can be configured to refract or generate virtual light associated with a virtual image. The first optical element can include a dielectric coating layer.

The method of manufacturing a lens for an augmented reality device can further include polishing a surface of the second lens piece.

Another aspect of the invention provides a lens manufactured by the method described above. Still another aspect of the invention provides an augmented reality device that includes a lens manufactured by the method described above.

An embodiment of the present invention having the features above can provide various advantageous effects including the following. However, an embodiment of the invention may not necessarily exhibit all of the effects below.

Certain embodiments of the invention can provide a lens for an augmented reality device having a reduced thickness and decreased weight.

Also, certain embodiments of the invention can reduce the time and cost required for manufacturing a lens for an augmented reality device while increasing precision and lowering the defect rate.

### BRIEF DESCRIPTION OF THE DRAWINGS

FIG. 1 illustrates how virtual light and real light are transmitted to the user in a lens for an augmented reality device according to a first disclosed embodiment of the invention.

FIG. 2 is a conceptual diagram of a lens for an augmented reality device according to the first disclosed embodiment of the invention.

FIG. 3 illustrates the incident angles of the virtual light that is transmitted through the first optical element and the virtual light that is reflected off the first optical element in the lens for an augmented reality device shown in FIG. 2.

FIG. 4 is a conceptual diagram of a lens for an augmented reality device according to a second disclosed embodiment of the invention.

FIG. 5 is a conceptual diagram of a lens for an augmented reality device according to a third disclosed embodiment of the invention.

FIG. 6 is a flow diagram for a method of manufacturing a lens for an augmented reality device according to an embodiment of the invention.

FIG. 7 is a perspective view of a first lens piece obtained during the manufacture of a lens for an augmented reality device according to an embodiment of the invention.

FIG. 8 is a perspective view of a first lens piece obtained during the manufacture of a lens for an augmented reality device according to another embodiment of the invention.

FIGS. 9A,9B and 9C are conceptual diagrams of first lens pieces that can be used to manufacture the lenses for an augmented reality device according to the first, second, and third disclosed embodiments of the invention.

FIG. 10 is a perspective view of a mold used in the manufacture of a lens for an augmented reality device according to an embodiment of the invention.

FIG. 11 is a perspective view of a second lens piece obtained during the manufacture of a lens for an augmented reality device according to an embodiment of the invention.

FIG. 12 is a perspective view of a second lens piece obtained during the manufacture of a lens for an augmented reality device according to another embodiment of the invention.

FIG. 13 is a perspective view of a third lens piece obtained during the manufacture of a lens for an augmented reality device according to an embodiment of the invention.

### DETAILED DESCRIPTIONOF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed by the present invention. In the description of the present invention, certain detailed explanations of the related art are omitted if it is deemed that they may unnecessarily obscure the essence of the invention.

The terms used in the present specification are merely used to describe particular embodiments and are not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

While such terms as “first” and “second,” etc., can be used to describe various components, such components are not to be limited by the above terms. The above terms are used only to distinguish one component from another.

Certain embodiments of the present invention will be described below in more detail with reference to the accompanying drawings. Those components that are the same or are in correspondence are rendered the same reference numeral, and redundant descriptions are omitted.

For convenience, the specification uses terms such as “front” and “rear”. In the descriptions below, a “rear side” refers to the side facing the user e, and a “rear surface” refers to the surface positioned at the rear side. A “front side” refers to the opposite side of the user e, i.e. the side facing the real world, and a “front surface” refers to the surface positioned at the front side.

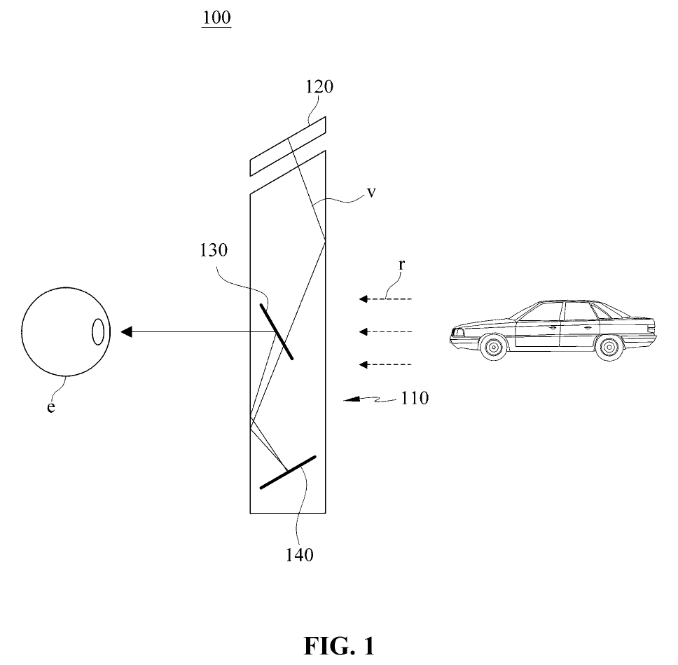

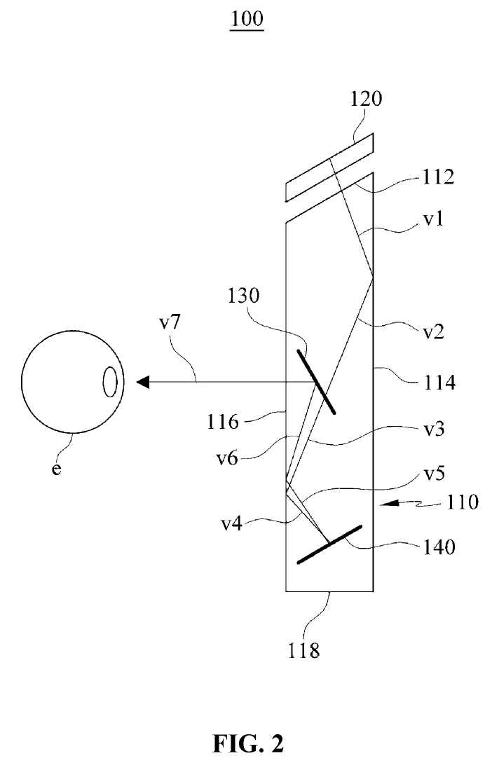

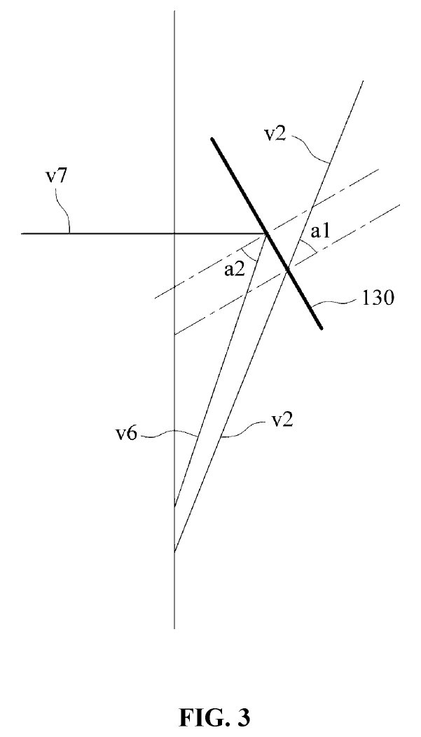

FIG. 1 illustrates how virtual light v and real light r are transmitted to the user in a lens 100 for an augmented reality device according to a first disclosed embodiment of the invention. FIG. 2 is a conceptual diagram of a lens 100 for an augmented reality device according to the first disclosed embodiment of the invention, and FIG. 3 illustrates the incident angles a1, a2 of the virtual light v3 that is transmitted through the first optical element 130 and the virtual light v6 that is reflected off the first optical element 130 in the lens 100 for an augmented reality device shown in FIG. 2.

Referring to FIGS. 1-3, a lens 100 for an augmented reality device according to an embodiment of the invention may provide the user with a virtual image and an actual image by transmitting virtual light v, which is outputted from a display module 120, and real light r, which is from the real world. That is, the lens 100 may transmit real light r, thus allowing the user e to visually perceive actual images from the real world, and may additionally output virtual light v, thus allowing the user to perceive virtual images together with the actual images. A lens 100 for an augmented reality device according to a first disclosed embodiment of the invention may include an optical means 110, a first optical element 130, and a second optical element 140.

The virtual image may be emitted from a display module 120, reflected off a second portion 114 of the optical means 110, and then be provided to the user e (for instance, the pupil of the user) by way of the first optical element 130 and the second optical element 140. The real light r from objects of the actual world can pass through the second portion 114 and third portion 116 of the optical means 110 to be provided to the user. In this way, the lens 100 for an augmented reality device can provide augmented reality by providing a virtual image and a real image to the user simultaneously.

A lens 100 for an augmented reality device based on this embodiment can be implemented for a device having the shape of eyeglasses, but the invention is not limited by the shape and usage of the augmented reality device.

The display module 120 generating the virtual image can correspond to a display that is based on a microdisplay, transparent OLED, LCOS (liquid crystal on silicon), DLP (digital light processing), and LED. The display module may be fabricated in a miniature size, generally between 0.2 to 1 inch, and may be characterized by maintaining a high resolution and high luminance in spite of its miniature size. The display module 120 may be installed at a position close the user’s eyes (within the eyeglasses) and can be adjusted such that the virtual image and the real image passing through the optical means 110 are superimposed in a natural manner. In particular, augmented reality glasses can be designed to provide information without obstructing the user’s field of vision by inserting a transparent display in the lens itself or by arranging the display in the frame. In certain embodiments of the invention, the display module 120 may serve only to refract light that is generated at another component.

In a lens 100 for an augmented reality device according to this embodiment, the display module 120 can be arranged on one side on the exterior of the optical means 110.

The optical means 110 can have a particular shape (for instance, a lens shape) and can be made from a glass or transparent synthetic resin material that allows the transmission of real light r. The optical means 110 can be made from a material having a certain degree of transparency and a certain refractive index, where the light transmittance can be adjusted by forming a coating layer on an exterior surface (for instance, the second portion 114).

The optical means 110 can include a first portion 112 through which the virtual light v for the virtual image generated by the display module 120 may enter. Also, the optical means 110 can include a second portion 114, through which may pass the real light r from real images generated by real objects, and a third portion 116, through which the virtual light and the real light may be outputted to the user e. In cases where the optical means 110 is shaped as an eyeglass lens, the second portion 114 can correspond to the surface arranged on the real object side, and the third portion 116 can correspond to the surface arranged on the user side.

The first portion 112 can correspond to the surface arranged between the second portion 114 and third portion 116 on the display module 120 side, and the fourth portion 118 can correspond to the surface arranged between the second portion 114 and third portion 116 on the opposite of the first portion 112

The first portion 112, second portion 114, third portion 116, and fourth portion 118 can be formed as flat surfaces, curved surfaces, or combinations of flat and curved surfaces.

The display module 120 can be arranged with an inclination, so that the virtual light v from the display module 120 may arrive at the second portion 114 at an inclined angle. In the same manner as the display module 120 arranged thus with an inclination, the first portion 112 can also be formed with an inclination, and the display module 120 and first portion 112 can be arranged to be parallel to each other.

The virtual light v1 outputted from the display module 120 can be reflected off the inner surface of the second portion 114 and then arrive at the first optical element 130. Thus, as the virtual light v1 outputted from the display module 120 does not arrive at the first optical element 130 directly but rather arrives after being reflected off the second portion 114, the incident angle of the virtual light v2 arriving at the first optical element 130 can be reduced. In turn, reducing the incident angle of the virtual light v2 can increase optical efficiency by preventing optical loss in the virtual light v2 and can also reduce the thickness of the optical means 110.

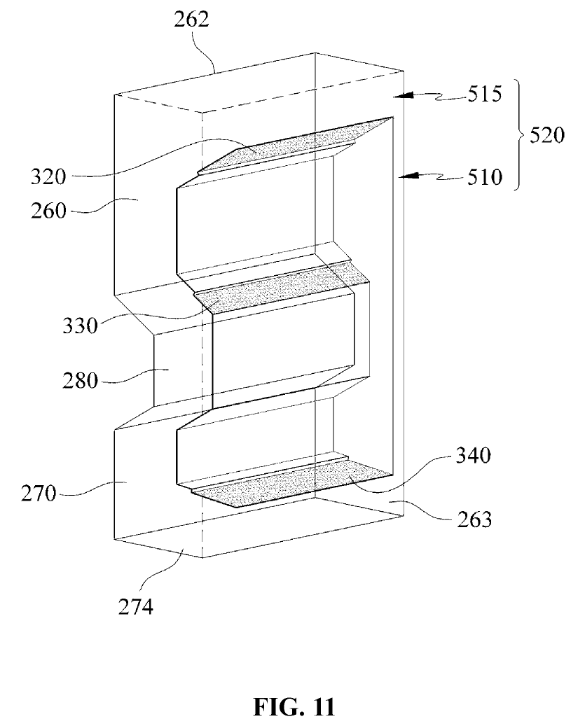

The first optical element 130 and the second optical element 140 can be positioned within the optical means 110, and as in the example illustrated in FIG. 11, it is also possible to have the display module 120 arranged together within the optical means 110 in certain embodiments of the invention.

The virtual light v2 reflected off the second portion 114 of the optical means 110 may arrive at the first optical element 130, and the first optical element 130 can either transmit or reflect the incident virtual light v1, v6 depending on the incident angle. That is, the virtual light v2 that arrives after being reflected by the second portion 114 of the optical means 110 can be transmitted through the first optical element 130 (denoted as v3) and can then arrive at and be reflected by the third portion 116. However, the virtual light v6 that has been reflected off the third portion 116 may be reflected by the first optical element 130 to become virtual light v7. The virtual light v7 reflected by the first optical element 130 can be transmitted to the user e.

The first optical element 130 can include a coating layer. The coating layer can correspond to a dielectric coating layer, where the dielectric coating layer can be formed from magnesium, calcium fluoride, and various metal oxides. The dielectric coating layer can determine the reflectance and transmittance values for different incident angles of the light. Thus, the reflectance and transmittance of the first optical element 130 can be controlled by using the thickness, number of layers, composition, etc., of the dielectric coating layer.

The coating layer can be formed on one side or both sides of the first optical element 130. In cases where coating layers are formed on both sides, a coating layer of the same structure can be formed on each side, whereby the optical path of the virtual light transmitted through the first optical element 130 can remain unchanged.

The surface of the first optical element 130 on which the virtual light v6 is reflected can be formed as an aspheric surface, and the virtual light v6 can be provided to the user e after being reflected off the first optical element 130. By forming the coating layer as an aspheric surface, it is possible to generate an augmented reality image with the optical path adjusted for different incident positions of the virtual light v6.

Referring to FIG. 3, the incident angle a1 at which the virtual light v2 arrives at the first optical element 130 can be different from the incident angle a2 at which the virtual light v6 arrives at the first optical element 130. The incident angle a2 can be formed to be greater than the incident angle a1, so that virtual light v6 can be completely reflected and not transmitted through the first optical element 130. The incident angles a1 and a2 can both be formed to be greater than 0 degrees and smaller than 45 degrees.

The virtual light v3 that is transmitted through the first optical element 130 may be reflected off the inside of the third portion 116 of the optical means 110 to become reflected virtual light v4, which may then arrive at the second optical element 140. The second optical element 140 may reflect the virtual light v4 back towards the third portion 116 of the optical means 110. For this purpose, the second optical element 140 may be arranged with an incline facing the third portion 116 of the optical means 110.

The virtual light v5 reflected off the second optical element 140 may be reflected by the third portion 116 of the optical means 110 and then arrive again at the first optical element 130. The virtual light v6 arriving at the first optical element 130 can be reflected by the first optical element 130 (denoted as v7) and can then be transmitted to the user e.

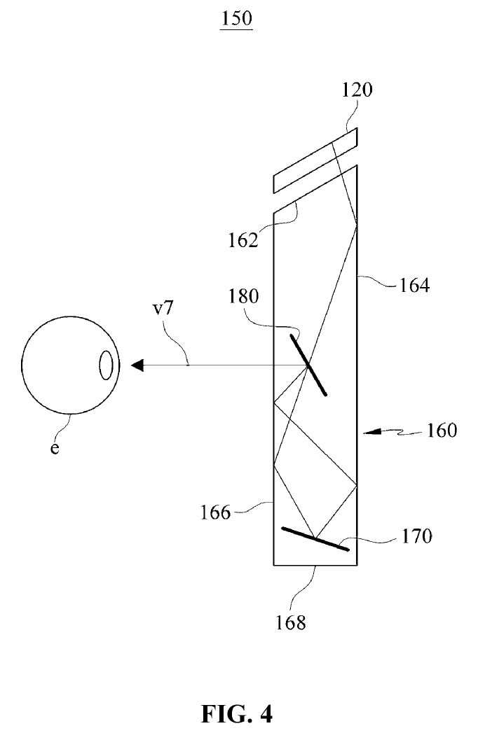

FIG. 4 is a conceptual diagram of a lens 150 for an augmented reality device according to a second disclosed embodiment of the invention.

Referring to FIG. 4, a lens 150 for an augmented reality device based on the second disclosed embodiment of the invention may be similar to a lens 100 for an augmented reality device based on the first disclosed embodiment in that the lens 150 may also include the display module 120, first optical element 130, and second optical element 140. However, in the lens 150 for an augmented reality device based on the second disclosed embodiment, the distance between the second optical element 140 and first optical element 130 may be greater, and the inclined angle of the second optical element 140 may be different.

In a lens 150 for an augmented reality device according to the second disclosed embodiment of the invention, the optical means 160 may include a first portion 162, a second portion 164, a third portion 166, and a fourth portion 168. As these portions are identical or similar to the portions of the optical means 110 in the first disclosed embodiment, redundant descriptions of these portions are omitted. However, since the lens 150 for an augmented reality device illustrated in FIG. 4 has the second optical element 140 separated to a further distance from the first optical element 130, it is possible to make the thickness of the optical means 160 even smaller while providing greater flexibility in the placement design of the optical elements 130, 140.

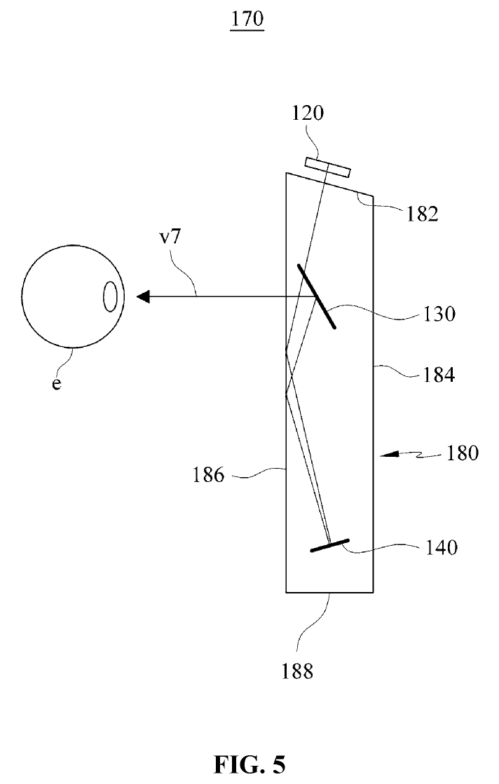

FIG. 5 is a conceptual diagram of a lens 170 for an augmented reality device according to a third disclosed embodiment of the invention.

Referring to FIG. 5, a lens 170 for an augmented reality device based on the third disclosed embodiment of the invention may be similar to lenses 100, 150 for an augmented reality device based on the first and second disclosed embodiments in that the lens 170 may also include the display module 120, first optical element 130, and second optical element 140. However, in the lens 170 for an augmented reality device based on the third disclosed embodiment, the distance between the display module 120 and the first optical element 130 may be smaller, and the inclined angle of the display module 120 may be different.

In a lens 170 for an augmented reality device according to the third disclosed embodiment of the invention, the optical means 180 may include a first portion 182, a second portion 184, a third portion 186, and a fourth portion 188. As these portions are identical or similar to the portions of the optical means 110 in the first disclosed embodiment, redundant descriptions of these portions are omitted.

In the lenses 100, 150 for an augmented reality device based on the first and second disclosed embodiments illustrated in FIGS. 2 and 4, the virtual light outputted from the display module 120 is first reflected off the second portion 184 before arriving at the first optical element 130. However, in the lens 170 for an augmented reality device illustrated in FIG. 5, the virtual light outputted from the display module 120 can arrive directly at the first optical element 130 without being reflected off a portion of the optical means 180. This structure can also reduce the thickness of the optical means 180 while providing greater flexibility in the placement design of the display module 120 and the optical elements 130, 140.

In the lenses 100, 150, 170 for an augmented reality device illustrated in FIGS. 1-5, the virtual light v outputted from the display module 120 is transmitted through the first optical element 130 instead of being routed to avoid the first optical element 130. Typically, if the virtual light v were transmitted directly through the first optical element 130, the light would be reflected off the bottom portion (fourth portion 118) of the lens and would form a large incident angle upon arriving back at the first optical element 130, thereby resulting in a considerably large optical loss as per the Fresnel equations. In a lens 100, 150, 170 for an augmented reality device according to an embodiment of the invention, however, the virtual light v3 that has passed through the first optical element 130 may be propagated along a path along which the light is reflected off the second optical element 140 and the second portion 114 or third portion 116 of the optical means 110, so that the light may form a small incident angle when returning to the first optical element 130. In this way, since the virtual light v does not have to follow a path that avoids the first optical element 130, the overall thickness of the lens 100, 150, 170 for an augmented reality device can be significantly reduced.

As illustrated in FIGS. 1-5, a lens 100, 150, 170 for an augmented reality device according to an embodiment of the invention can include a display module 120, which may correspond to a part of the overall augmented reality device. An aspect of the invention can provide an augmented reality device, which may include the lens 100, 150, 170 for an augmented reality device and may further include a control unit that controls the output of the virtual light v by the display module 120, an image processing unit that processes the image for the virtual light v, and the like.

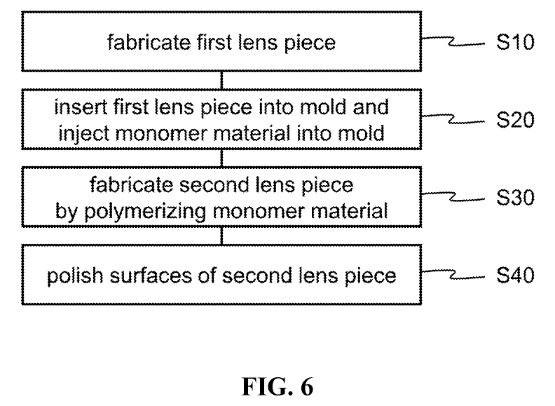

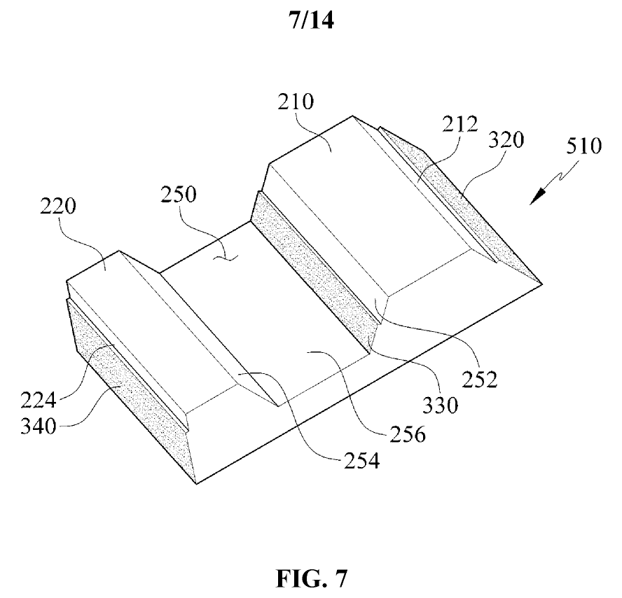

The following provides a more detailed method of manufacturing a lens for an augmented reality device according to an embodiment of the invention. FIG. 6 is a flow diagram for a method of manufacturing a lens for an augmented reality device according to an embodiment of the invention. FIGS. 7-13 illustrate certain processes involved in the method of manufacturing a lens for an augmented reality device.

Referring to FIG. 6, a method of manufacturing a lens for an augmented reality device based on an embodiment of the invention can first include fabricating a first lens piece 510 (operation S10).

FIG. 7 illustrates a first lens piece 510 that can be fabricated according to an embodiment of the invention. As illustrated in FIG. 7, the first lens piece 510 can be fabricated to include a light-emitting element 320, a first optical element 330, and a second optical element 340.

The light-emitting element 320 can form the display module 120 in the completed lens for an augmented reality device. That is, the light-emitting element 320 can include a display module 120 that either generates virtual light v or refracts virtual light v that has already been generated. Examples of the light-emitting element 320 can include displays based on a microdisplay, transparent OLED, LCOS, DLP, LED, and the like.

The first optical element 330 can form the first optical element 130 in the completed lens for an augmented reality device. The first optical element 330 can include, for example, a dielectric coating layer, which can be formed from magnesium, calcium fluoride, and various metal oxides. Similarly, the second optical element 340 can form the second optical element 140 in the completed lens for an augmented reality device. The second optical element 340 can also include a dielectric coating layer, which can be formed from magnesium, calcium fluoride, and various metal oxides.

FIG. 7 illustrates a first lens piece 510 according to certain embodiments of the invention, as seen from the rear. As illustrated in FIG. 7, the first lens piece 510 can include an inclined surface 252, which can be formed between the end facing a first direction (the end pointing upper right in FIG. 7) and the end facing a second direction (the end pointing lower left in FIG. 7) along the lengthwise direction (the lower left to upper right diagonal direction in FIG. 7), where the inclined surface 252 can form a particular angle with respect to the lengthwise direction. The first optical element 330 may be formed on this inclined surface 252, and as such, the angle of the inclined surface 252 can be designed to correspond to the desired angle of the first optical element 130 in the lens for an augmented reality device described above.

In order that the inclined surface 252 may be formed in the first lens piece 510, a cavity 250 can be formed in a surface of the first lens piece 510. In the example illustrated in FIG. 7, a cavity 250 is formed in the rear surface of the first lens piece 510, with the result that a mound 210, 220 is formed on each of the first-direction side and second-direction side of the cavity 250. The surface on the first-direction side of the mound 210 corresponds to the first-direction end 212 of the overall first lens piece 510, while the surface on the second-direction side of the mound 210 corresponds to the first-direction surface 252 of the cavity 250. The surface on the first-direction side of the mound 220 corresponds to the second-direction surface 254 of the cavity 250, while the surface on the second-direction side of the mound 220 corresponds to the second-direction end 224 of the overall first lens piece 510. The degree by which the mounds 210, 220 on both sides of the cavity 250 protrude compared to the cavity 250 do not necessarily have to be the same. The recessed surface 256 of the cavity 250 corresponds to the most deeply recessed surface between the first-direction surface 252 and second-direction surface 254 of the cavity 250.

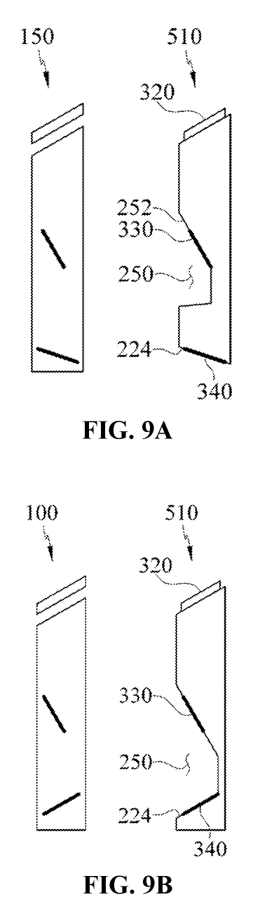

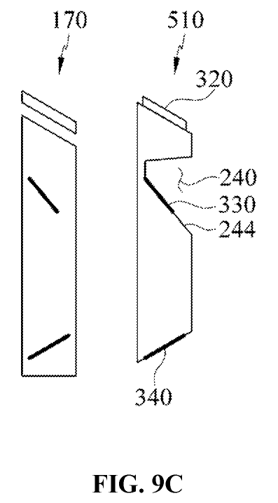

FIG. 7 merely shows an example of a first lens piece 510, and a first lens piece 510 in which an inclined surface 252 of a particular angle is formed between a first-direction end 212 and a second-direction end 224 can be implemented in any of a variety of shapes. For example, while the example illustrated in FIG. 7 has a cavity 250 formed only in the middle of the first lens piece 510 such that mounds 210, 220 are formed on both the first-direction side and the second-direction side of the cavity 250, certain embodiments of the invention can have the cavity 250 extending to the first-direction end 212 or the second-direction end 224 of the first lens piece 510 such that only one mound 210, 220 is formed. Also, while the example illustrated in FIG. 7 has the cavity 250 formed in the rear surface of the first lens piece 510, it is also possible to form a structure in which the cavity 250 is formed in the front surface of the first lens piece 510. In certain embodiments of the invention, the first lens piece 510 can be formed with both a cavity 240 formed in the front surface (see FIG. 9C) and a cavity 250 formed in the rear surface.

Referring to FIG. 7, the first-direction end 212 of the first lens piece 510 can be formed to be at a particular angle with respect to the lengthwise direction, and the light-emitting element 320 can be formed on this end 212. For this purpose, the angle of the surface of the first-direction end 212 of the first lens piece 510 can be designed to correspond to the desired angle of the display module 120 in the lens for an augmented reality device described above.

The second-direction end 224 of the first lens piece 510 can also be formed to be at a particular angle with respect to the lengthwise direction, and the second optical element 340 can be formed on this end 224. For this purpose, the angle of the surface of the second-direction end 224 of the first lens piece 510 can be designed to correspond to the desired angle of the second optical element 140 in the lens for an augmented reality device described above.

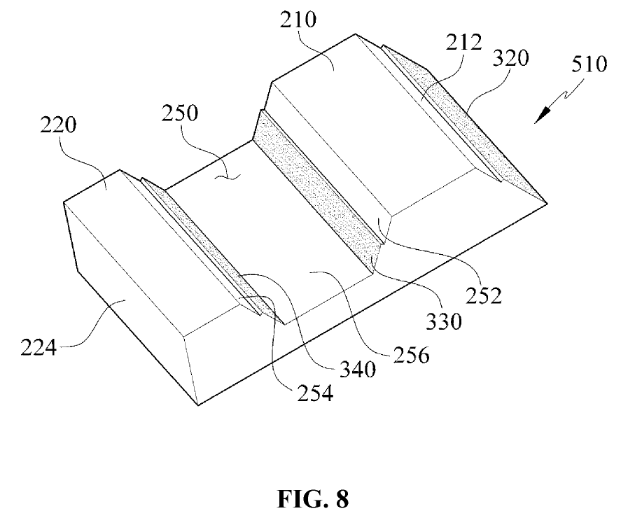

FIG. 8 illustrates a first lens piece 510 according to certain embodiments of the invention, as seen from the rear. The first lens piece 510 illustrated in FIG. 8 is generally similar to that illustrated in FIG. 7, differing only in the portion where the second optical element 340 is formed. That is, whereas the embodiment illustrated in FIG. 7 has the second optical element 340 formed on the second-direction end 224 of the first lens piece 510, certain embodiments of the invention can have the second optical element 340 formed on the second-direction surface 254 of the cavity 250, as illustrated in FIG. 8. In other words, a first inclined surface can be formed on the first-direction surface 252 of the cavity 250, and a second inclined surface can be formed on the second-direction surface 254 of the cavity 250, with the first optical element 330 formed on the first inclined surface and the second optical element 340 formed on the second inclined surface.

When forming the cavity 250 in the first lens piece 510, it may be advantageous to have the first-direction surface 252 of the cavity 250 facing the second direction and the second-direction surface 254 of the cavity 250 facing the first direction at shallow angles, as this provides advantages both in the fabrication of the first lens piece 510 and in the subsequent fabrication of a second lens piece 520 by a process using the first lens piece 510. Therefore, the decision on whether the second optical element 340 is to be formed on the second-direction surface 254 of the cavity 250 or on the second-direction end 224 of the first lens piece 510 can be made in consideration of the angle required for the inclined surface on which the second optical element 340 is to be formed.

In cases where the first lens piece 510 is formed with a cavity 250 in its surface, the cavity 250 can also serve to align and secure the first lens piece 510 with and to the mold 600 during the operation of inserting the first lens piece 510 into the mold 600 for fabricating the second lens piece 520. In such cases, the optical elements 330, 340 can be formed at relative deep positions on the inner surfaces 252, 254, i.e., positions adjacent to the recessed surface 256, without being formed over the entire inner surfaces 252, 254 of the cavity 250.

FIGS. 9A to 9C are conceptual diagrams of first lens pieces 510 that can be used to manufacture the lenses 100, 150, 170 for an augmented reality device according to certain embodiments of the invention.

FIG. 9A shows an example of a first lens piece 510 that can be used when manufacturing the lens 150 illustrated in FIG. 4. As in the first lens piece 510 illustrated in FIG. 9A, the light-emitting element 320 can be formed on the first-direction end 212 of the first lens piece 510, and as such, the first-direction end 212 can be formed in the angle required for the display module 120 of the lens 150. Also, the first optical element 330 can be formed on the first-direction surface 252 of the cavity 250, and as such, the first-direction surface 252 of the cavity 250 can be formed in the angle required for the first optical element 130 of the lens 150. Furthermore, the second optical element 340 can be formed on the second-direction end 224 of the first lens piece 510, and as such, the second-direction end 224 can be formed in the angle required for the second optical element 140 of the lens 150.

FIG. 9B shows an example of a first lens piece 510 that can be used when manufacturing the lens 100 illustrated in FIG. 2. As in the first lens piece 510 illustrated in FIG. 9B, the second optical element 340 can be formed on the second-direction surface 254 of the cavity 250, and as such, the second-direction surface 254 of the cavity 250 can be formed in the angle required for the second optical element 140 of the lens 100.

FIG. 9C shows an example of a first lens piece 510 that can be used when manufacturing the lens 170 illustrated in FIG. 5. As in the first lens piece 510 illustrated in FIG. 9C, it is possible also to form a cavity 240 in the front surface of the first lens piece 510. As in the first lens piece 510 illustrated in FIG. 9C, the first optical element 330 can be formed on the second-direction surface 244 of the cavity 240, and as such, the second-direction surface 244 of the cavity 240 can be formed in the angle required for the first optical element 130 of the lens 170.

According to an embodiment of the invention, fabricating the first lens piece 510 (operation S10) can include injecting a preliminary material into a preliminary mold (not shown) having a shape corresponding to that of the first lens piece 510 and polymerizing the preliminary material. Here, the preliminary material can be prepared to be of the same composition as that of the monomer material used in the fabrication of the second lens piece 520 described below. That is, the first lens piece 510 can be composed of the polymer material that is obtained by injecting a monomer material into a preliminary mold (not shown), which may be formed in a shape corresponding to the cavity 240, 250, mounds 210, 220, etc., to mold the monomer material and then polymerizing the monomer material.

In an embodiment of the invention, the operation of injecting the preliminary material into the preliminary mold (not shown) can include first arranging one or more of the light-emitting element 320, first optical element 330, and second optical element 340 at designated positions of the preliminary mold (not shown). Then, injecting the preliminary material (monomer material) into the preliminary mold (not shown) and polymerizing the preliminary material can provide the first lens piece 510 that is equipped with the light-emitting element 320, first optical element 330, and second optical element 340. Of course, it is also possible to first mold the main body of the first lens piece 510 from the preliminary material (monomer material) and then separately perform an operation of attaching and/or depositing at least one of the light-emitting element 320, first optical element 330, and second optical element 340 onto the main body.

The first lens piece 510 can also be fabricated by other methods. For example, in an embodiment of the invention, the fabricating of the first lens piece 510 (operation S10) can include molding the main body of the first lens piece 510 without any inclined surfaces formed by a cavity 250, etc., cutting and/or polishing the main body of the first lens piece 510 to form the cavity 250, mounds 210, 220, etc., and attaching and/or depositing at least one of the light-emitting element 320, first optical element 330, and second optical element 340 onto the inclined surfaces formed by the cutting and/or polishing.

The light-emitting element 320 and the second optical element 340 do not necessarily have to be formed inside the lens 100, 150, 170. Just as the display module 120 is depicted in FIGS. 1-5 as being attached to the first portion 112, 162, 182 of the optical means 110, 160, 180, so too can the light-emitting element 320 be attached to a first-direction end of the second lens piece 520 or third lens piece 530 described below. Therefore, although FIGS. 7-9C illustrate examples in which the light-emitting element 320 is formed on the first lens piece 510, it is also possible to fabricate the first lens piece 510 first without the light-emitting element 320 and then afterwards attach the light-emitting element 320 onto the second lens piece 520 or third lens piece 530.

Similarly, the second optical element 140 of the lens 100, 150, 170 can also be implemented in a form that is attached to the fourth portion 118, 168, 188 of the optical means 110, 160, 180. Therefore, although FIG. 7 through FIG. 9C illustrate examples in which the second optical element 340 is formed on the first lens piece 510, it is also possible to fabricate the first lens piece 510 first without the second optical element 340 and then afterwards attach the second optical element 340 onto the second lens piece 520 or third lens piece 530.

Referring again to FIG. 6, after the first lens piece 510 has been fabricated, an operation of inserting the first lens piece 510 into a mold 600 and injecting a monomer material into the mold 600 (operation S20) can be performed.

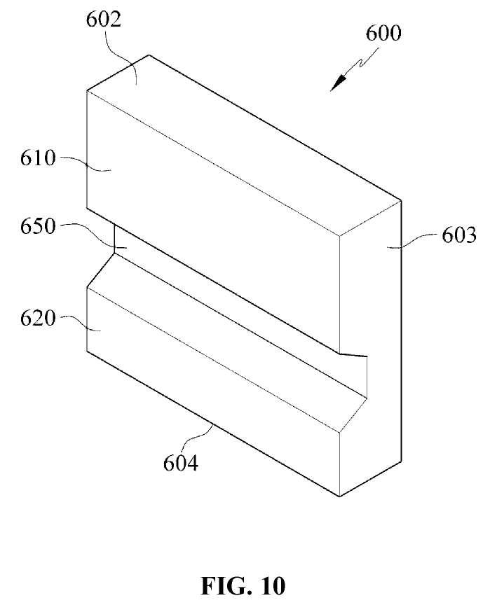

FIG. 10 is a perspective view, as seen from the rear, of a mold 600 used in the manufacture of a lens for an augmented reality device according to an embodiment of the invention.

Referring to FIG. 10, the mold 600 is for molding a second lens piece 520 and thus has a shape corresponding to that of the second lens piece 520. To facilitate the understanding of the invention, FIG. 10 depicts the mold 600 in an erected orientation corresponding to the orientation of the lens being manufactured. However, the operation of inserting the first lens piece 510 into a mold 600 and injecting a monomer material into the mold 600 (operation S20) can be performed with the mold 600 oriented such that the base plates 610, 620 face downward.

The base plates 610, 620, first-direction end 602, side plates 603, and second-direction end 604 can form a molding space on the inner side. To enable an inserting of the first lens piece 510 and a monomer material to the inside of the mold 600, the front of the mold 600 can be at least partially open. Into the molding space of the mold 600, the first lens piece 510 can be inserted, and afterwards a monomer material can be injected.

According to an embodiment of the invention, the mold 600 can include a protrusion 650 at a position corresponding to the cavity 250 of the first lens piece 510. The protrusion 650 can protrude towards the cavity 250 of the first lens piece 510 within the molding space. Although the protrusion 650 is depicted as being recessed inward in FIG. 10 due to the fact that FIG. 10 shows the rear side of the mold 600 as seen from the outside, it should be appreciated that this part protrudes into the molding space when regarded from the inner side of the mold 600.

The protrusion 650 of the mold 600 can be formed such that the protrusion 650 does not contact all of the inner surfaces 252, 254 of the cavity 250 of the first lens piece 510 and can be formed such that there is a gap from the recessed surface 256. This can be implemented, for example, by forming the protrusion 650 such that the length by which the protrusion protrudes towards the first lens piece 510 within the molding space is smaller than the depth by which the recessed surface 256 of the cavity 250 is recessed in the first lens piece 510. More specifically, the protrusion 650 can be configured not to contact at least a portion of the optical elements 330, 340 formed on the inclined surfaces 252, 254 of the cavity 250.

In cases where a cavity 250 is formed in the first lens piece 510 and a protrusion 650 is formed in the mold 600, the first lens piece 510 can be arranged in the molding space of the mold 600 such that the protrusion 650 of the mold 600 is inserted into the cavity 250 of the first lens piece 510. As the protrusion 650 of the mold 600 is inserted into the cavity 250, the first lens piece 510 can be aligned and secured at the correct position within the molding space of the mold 600. The protrusion 650 of the mold 600 can align and secure the first lens piece 510, for example, by partially contacting the first-direction surface 252 and second-direction surface 254 of the cavity 250. Of course, the first lens piece 510 can also be in contact with other parts of the mold 600, such as the base plates 610, 620, first-direction end 602, side plates 603, second-direction end 604, etc. These can aid the aligning and securing of the first lens piece 510 with respect to the mold 600.

Although the example illustrated in FIG. 10 has the first-direction end 602 and second-direction end 604 of the mold 600 formed orthogonal to the side plates 603, these can be formed in other shapes in other preferred embodiments of the invention. For example, in order that the molded second lens piece 520 or a third lens piece 530 obtained therefrom may be directly mounted onto AR glasses, etc., the mold 600 can be designed such that the first-direction end 602, side plates 603, and second-direction end 604, i.e., the edges of the mold 600, form curves corresponding to an eyeglass frame. Similarly, the base plates corresponding to the front surface and/or rear surface of the mold 600 can also be designed to form curved surfaces corresponding to the surfaces of an eyeglass lens. This can minimize the post-processing required for the second lens piece 520 or the third lens piece 530 obtained therefrom.

After the first lens piece 510 has been inserted into the mold 600, a monomer material can be injected into the mold 600. As mentioned above, the monomer material injected into the mold 600 can be of the same composition as the preliminary material used in fabricating the first lens piece 510. The monomer material of a fluid state can fill the gaps between the mold 600 and the first lens piece 510 within the molding space of the mold 600. In particular, the injecting of the fluid state monomer material into the mold 600 can be performed such that the first optical element 330 is covered by the monomer material. If applicable, the light-emitting element 320 and the second optical element 340 can also be covered by the monomer material.

As described above, it is also possible to have the light-emitting element 320 and the second optical element 340 added after the fabrication of the first lens piece 510 is complete. In certain embodiments of the invention, the injecting of the monomer material into the mold 600 can include first arranging one or more of the light-emitting element 320 and second optical element 340 at designated positions of the mold 600.

Referring again to FIG. 6, after the first lens piece 510 and the monomer material have been filled in the mold 600, an operation of polymerizing the monomer material to fabricate the second lens piece 520 (operation S30) can be performed.

The monomer material injected into the mold 600 can undergo a polymerization process to form a polymer material. Depending on the properties of the monomer material, any of a variety of polymerization processes can be used, such as photopolymerization, thermal polymerization, radical polymerization, cross-linking polymerization, etc. The polymerization process can cause the fluid monomer material to form a solid polymer material, thereby providing a second lens piece 520 made of the polymer material.

FIG. 11 illustrates a second lens piece 520 that can be obtained from the mold 600. during the manufacture of a lens for an augmented reality device according to an embodiment of the invention. FIG. 11 also depicts the first lens piece 510 that is embedded within the second lens piece 520.

The second lens piece 520 can be formed in a shape corresponding to the molding space of the mold 600 and therefore can include rear surfaces 260, 270, a first-direction end 262, side surfaces 263, and a second-direction end 274, which correspond to the base plates 610, 620, first-direction end 602, side plates 603, and second-direction end 604 of the mold 600. In cases where the mold 600 includes a protrusion 650, a recessed surface 280 can be formed correspondingly in the rear surface of the second lens piece 520. Of course, in cases where the mold 600 does not include a protrusion 650, the recessed surface 280 can be omitted in the second lens piece 520.

One or more of the rear surfaces 260, 270, first-direction end 262, side surfaces 263, and second-direction end 274 of the second lens piece 520 can be formed in a measurement corresponding to that of a surface of the lens 100, 150, 170 for an augmented reality device being manufactured.

Since the monomer material used in molding the second lens piece 520 has the same composition as the preliminary material used in fabricating the first lens piece 510, the main body of the first lens piece 510 and the main body of the second lens piece 520 may have the same refractive index, and therefore the boundary of the first lens piece 510 within the second lens piece 520 would not be visible. That is, although FIG. 11 marks the boundary of the first lens piece 510 within the second lens piece 520 in order to aid the reader’s understanding of the invention, the first lens piece 510 would not be distinguishable in an actually fabricated second lens piece 520. Of course, since the light-emitting element 320 and the first and second optical elements 330, 340 are also made from transparent materials, these would not be visually conspicuous, either.

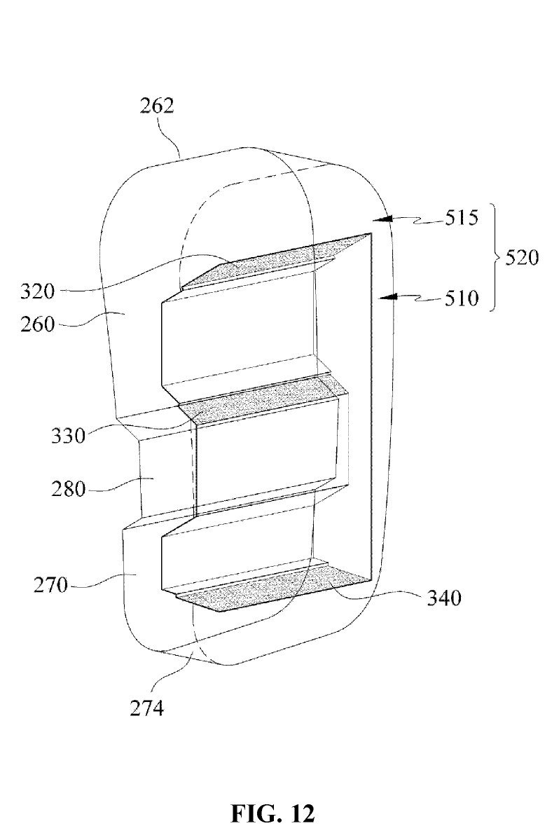

FIG. 12 is a perspective view of a second lens piece 520 obtained during the manufacture of a lens for an augmented reality device according to another embodiment of the invention.

As described above, the first-direction end 602, side plates 603, and second-direction end 604 of the mold 600 do not necessarily have to be formed as flat planes that are orthogonal to one another, and these can form curves corresponding to an eyeglass frame in a preferred embodiment of the invention. In such cases, the second lens piece 520 obtained as a result of polymerizing the monomer material (operation S30) can have a shape similar to that illustrated in FIG. 12. In the second lens piece 520 illustrated in FIG. 12, the first-direction end 262, side surfaces 263, and second-direction end 274 are formed along a continuous curve and, as a whole, form a shape corresponding to the edge of a left or right lens for an eyeglass frame. As described above, the rear surface and/or front surface of the second lens piece 520 can also be formed as a curved surface corresponding to that of an eyeglass lens.

The operation of fabricating the second lens piece 520 can be regarded as joining the first lens piece 510 with another lens that surrounds the first lens piece 510. Coupling a hardened first lens piece 510 with another hardened lens piece with an existing method requires processing the surfaces of the two lens pieces for precise contact, polishing the processed surfaces to obtain the original level of transparency, and applying an adhesive to the areas of contact between the two lens pieces. To account for the manufacturing tolerances of each lens piece, the two lens pieces must be fabricated with slightly larger measurements and then must be processed and polished in corresponding amounts. This method requires several steps, resulting in increases in manufacturing time and cost and inevitably causing a certain amount of defects.

In contrast, in an embodiment of the invention, the part of the second lens piece 520 excluding the first lens piece 510 (hereinafter referred to as the “added part”) can be injected as a monomer material of a fluid state around the already polymerized and hardened first lens piece 510. This provides the advantage that, as long as there are no errors in the light-emitting element 320 and the optical elements 330, 340, the manufacturing tolerances in other parts of the first lens piece 510 can be ignored. There is no need to process and polish the areas of contact between the first lens piece 510 and the added part 515, neither is there a need to apply an adhesive to said areas.

Also, as the monomer material is polymerized and combined with the first lens piece 510, there is no boundary formed between the first lens piece 510 and the added part 515, so that there is no loss or distortion in the transmission of light. Once the mold 600 has been fabricated with a high level of precision, it becomes possible also to fabricate the second lens piece 520 with a very high level of precision by managing only the process of injecting the monomer material. Consequently, a method of manufacturing a lens for an augmented reality device according to an embodiment of the invention can reduce the time and cost associated with manufacturing the lens, increase precision, and lower the defect rate.

Referring again to FIG. 6, after the second lens piece 520 has been fabricated, an operation of polishing the surfaces of the second lens piece 520 (operation S40) can be performed. During this operation, a process of polishing one or more of the rear surface and front surface of the second lens piece 520 can be performed. A process of polishing the first-direction end 262, side surfaces 263, and second-direction end 274 of the second lens piece 520 can also be performed if necessary. In cases where the mold 600 includes a protrusion 650 so that a recessed surface 280 is formed in the rear surface of the second lens piece 520, a process of polishing the rear surfaces 260, 270 of the second lens piece 520 such that these parts form surfaces that are continuous with the recessed surface 280 can also be performed. It can be advantageous if the first optical element 330, which may be formed during the fabrication of the first lens piece 510, is not formed in a part that is to be polished and removed.

It is possible to add the light-emitting element 320 and the second optical element 340 during the operation of fabricating the second lens piece 520 (operation S30). That is, according to certain embodiments of the invention, the operation of fabricating the second lens piece 520 can include attaching and/or depositing one or more of the light-emitting element 320 and the second optical element 340 onto the main body of the second lens piece 520.

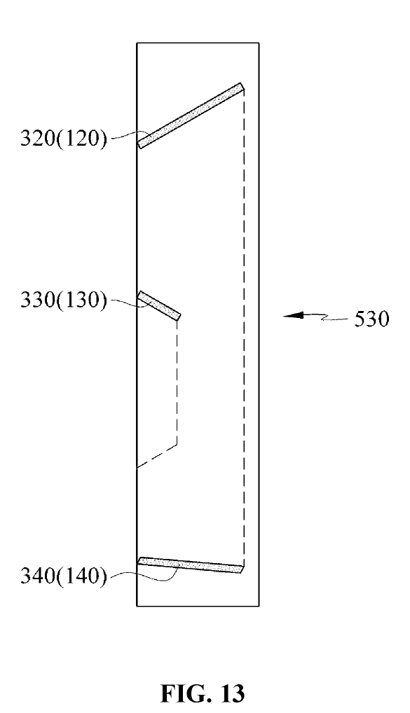

FIG. 13 is a perspective view of a third lens piece 530 obtained after the operation of polishing the surfaces of the second lens piece 520 (operation S40). In FIG. 13, the dotted lines are intended to mark the part of the third lens piece 530 that used to be the first lens piece 510. As illustrated in FIG. 13, the third lens piece 530 can be fabricated in the form of a lens having the light-emitting element 320, first optical element 330, and second optical element 340 embedded therein. As described above, the light-emitting element 320, first optical element 330, and second optical element 340 can correspond to the display module 120, first optical element 130, and second optical element 140, respectively, and therefore the third lens piece 530 can be used as the lens 100, 150, 170 for an augmented reality device illustrated in FIGS. 1-5.

FIG. 13 provides a conceptual diagram of the third lens piece 530 and thus depicts the sides as a rectangle, but as described above, the rear and front surfaces of the third lens piece 530 can be processed as curved surfaces in consideration of the optical path of the virtual light v created by the light-emitting element 320 and optical elements 330, 340.

As described above, the mold 600 for fabricating the second lens piece 520 does not necessarily have to include a protrusion 650. In such cases, the polishing applied during the polishing of the surfaces of the second lens piece 520 (operation S40) can be performed by a very small amount. That is, the second lens piece 520 itself can be fabricated to be similar to the form illustrated in FIG. 13.

As necessary, a method of manufacturing a lens for an augmented reality device can further include post-processing the surfaces of the third lens piece 530. The post-processing for the surfaces of the third lens piece 530 can include, for example, applying an anti-reflective (AR) coating, an anti-fingerprint (AF) coating, etc.

According to certain embodiments of the invention presented above, a lens for an augmented reality device can be provided in which the virtual light v outputted from the display module 120 is emitted along a path that first passes through the first optical element 130, so that the thickness and weight of the lens may be reduced.

In particular, a method of manufacturing a lens for an augmented reality device can involve first fabricating a first lens piece 510 and then fabricating a second lens piece 520 by a method of molding a monomer material around the first lens piece 510, where the monomer material has the same composition as that of the preliminary material used in fabricating the first lens piece 510. Since the first lens piece 510 and the added part 515 around it are made of the same composition and are integrated by a polymerization process, there is no boundary between these parts, so that there is no loss or distortion during light transmission. Also, once the mold 600 has been fabricated with a high level of precision, it becomes possible also to fabricate the second lens piece 520 with a very high level of precision by managing only the operation of injecting the monomer material.

While the foregoing provides a description with reference to an embodiment of the present invention, it should be appreciated that a person having ordinary skill in the relevant field of art would be able to make various modifications and alterations to the present invention without departing from the spirit and scope of the present invention set forth in the scope of claims below.

What is claimed is:

1. A method of manufacturing a lens for an augmented reality device, the method comprising:
fabricating a first lens piece, the first lens piece having an inclined surface between a first-direction end and a second-direction end of the first lens piece with respect to a lengthwise direction, the inclined surface being exposed to an outer side and forming a particular angle with respect to the lengthwise direction, the inclined surface having a first optical element formed thereon;
inserting the first lens piece into a mold and injecting a monomer material into the mold such that the first optical element is covered with the monomer material; and
fabricating a second lens piece by polymerizing the monomer material.

2. The method of claim 1, wherein a cavity of a recessed form is formed in the first lens piece, and the inclined surface is formed on a first-direction surface of the cavity or a second-direction surface of the cavity.

3. The method of claim 2, wherein a first inclined surface is formed on the first-direction surface of the cavity, a second inclined surface is formed on the second-direction surface of the cavity, the first optical element is formed on the first inclined surface, and a second optical element is formed on the second inclined surface.

4. The method of claim 2, wherein the mold includes a protrusion protruding towards the cavity at a position corresponding to the cavity, and the protrusion is configured not to be in contact with at least a portion of the first optical element.

5. The method of claim 1, wherein the fabricating of the first lens piece comprises forming a second optical element on a first-direction end of the first lens piece.

6. The method of claim 1, wherein the fabricating of the first lens piece comprises:
injecting a preliminary material into a preliminary mold, the preliminary mold having a shape corresponding to a shape of the first lens piece, the preliminary material having a same composition as the monomer material; and
polymerizing the preliminary material.

7. The method of claim 1, wherein a light-emitting element is formed at a position of the second lens piece closer to a first-direction end of the second lens piece than the first optical element by:
forming the light-emitting element on a first-direction end of the first lens piece during the fabricating of the first lens piece, or
injecting the monomer material after arranging the light-emitting element at a first-direction end of the mold during the injecting of the monomer material, or
forming the light-emitting element on the first-direction end of the second lens piece during the fabricating of the second lens piece.

8. The method of claim 7, wherein the light-emitting element is configured to refract or generate virtual light associated with a virtual image.

9. The method of claim 1, wherein the first optical element comprises a dielectric coating layer.

10. The method of claim 1, further comprising:
polishing a surface of the second lens piece.

11. A lens manufactured by the method of claim 1.

12. An augmented reality device comprising a lens manufactured by the method of claim 1.
